(19) United States
(12) Patent Application Publication
(10) Pub. No.: US 2016/0260108 A1
(43) Pub. Date: Sep. 8, 2016

(54) OCCASION-BASED CONSUMER ANALYTICS

(71) Applicant: David Brian Bracewell, Richardson, TX (US)

(72) Inventor: David Brian Bracewell, Richardson, TX (US)

(21) Appl. No.: 15/061,701

(22) Filed: Mar. 4, 2016

Related U.S. Application Data
(60) Provisional application No. 62/128,823, filed on Mar. 5, 2015.

(51) Int. Cl. G06Q 30/02; G06Q 50/00; G06N 99/00; G06F 17/30

(52) U.S. Cl. CPC G06Q 30/0201; G06F 17/30684; G06F 17/30707; G06F 17/30864; G06Q 50/01; G06N 99/005

(57) ABSTRACT

A corpus of text data is accessed that includes a plurality of sentences and each of these sentences is parsed to determine, for each word, a corresponding meaning. A particular one of the sentences is determined to correspond to a particular occasion based on the determined meanings of one or more words of the particular sentence and is further determined to reference a product or service. A relationship is determined between the product or service and the particular occasion based on the particular sentence. One or more words of the particular sentence are determined to indicate a psychological characteristic of an author of the particular sentence. Consumer analytics data is generated to at least identify the relationship between the product or service and the particular occasion.

### RELATED APPLICATIONS

This application claims benefit to U.S. Provisional Patent Application Ser. No. 62/128,823, filed Mar. 5, 2015 and incorporated by reference herein in its entirety.

### TECHNICAL FIELD

This disclosure relates in general to the field of data analysis and, more particularly, to analyzing data for consumer markets.

### BACKGROUND

Customer analytics involves the analysis of data to attempt to understand or predict customer (or consumer) behavior and help make business decisions, such as through market segmentation and predictive analytics. Information derived from customer analytics can be used by businesses for direct marketing, site selection, customer relationship management, and other purposes. Online commerce has enabled more data to be collected describing customers' interactions with various brands and products. Ecommerce platforms have allowed businesses to obtain information, such as, a given customer's purchasing history, tendencies of certain consumers to purchase like combinations of products and services (e.g., “Consumers who bought this item also purchased . . . ”), other products a customer looked at before deciding to purchase another product, among other examples. Traditional, “brick-and-mortar” marketplaces have also implemented technology to better track customers' purchasing behavior and trends, allowing businesses to predict inventory patterns, preferences of individual stores' customers based on geography and demographic characteristics, among other examples.

In some respects, the quality of customer analytics is dependent on the quality of data obtained that describe aspects of the customers' behaviors. Traditional market research systems are based on techniques involving surveys, questionnaires, focus groups and panels for the collection of data to be analyzed to construct consumer insights. Other data can be obtained at the point-of-sale, such as through customer reward programs, business credit programs, and sales information.

### BRIEF SUMMARY

According to one aspect of the present disclosure, a corpus of text data can be accessed that includes a plurality of sentences and each of these sentences is parsed to determine, for each word, a corresponding meaning. A particular one of the sentences can be determined to correspond to a particular occasion based on the determined meanings of one or more words of the particular sentence and can be further determined to reference a product or service. A relationship can be determined between the product or service and the particular occasion based on the particular sentence. One or more words of the particular sentence can be determined to indicate a psychological characteristic of an author of the particular sentence. Consumer analytics data can be generated to at least identify the relationship between the product or service and the particular occasion.

### BRIEF DESCRIPTION OF DRAWINGS

FIG. 1 is a simplified block diagram illustrating an example system including a consumer analytics system in accordance with at least some implementations.

FIG. 2 is a simplified block diagram illustrating an example system including a consumer analytics system in accordance with at least some implementations.

FIG. 3 is a simplified schematic diagram representing a four-factor model for use in analysis of text for expressions of human sentiment in accordance with at least some implementations.

FIG. 4 is a simplified flow diagram representing processing of text documents by an example consumer analytics system in accordance with at least some implementations

FIG. 5 is a simplified flow diagram representing example techniques for providing occasion-based consumer analytics in accordance with at least some implementations

Like reference numbers and designations in the various drawings indicate like elements.

### DETAILED DESCRIPTION

The voice of the customer is often loudly pronounced through social media and the reviews they make online about the products they purchase and use and the companies they patron. This social data can be utilized by marketers to answer the who, why, what, where, when, and how surrounding their products. However, current approaches to mining consumer insights from social data mainly focus on the volume of sentiment and its trend over time. Other signals in the data are largely neglected. These signals include preferences, needs, wants, and actions, which may be more directly linked to consumers' attitudes and the social and personal factors that make up their behavior.

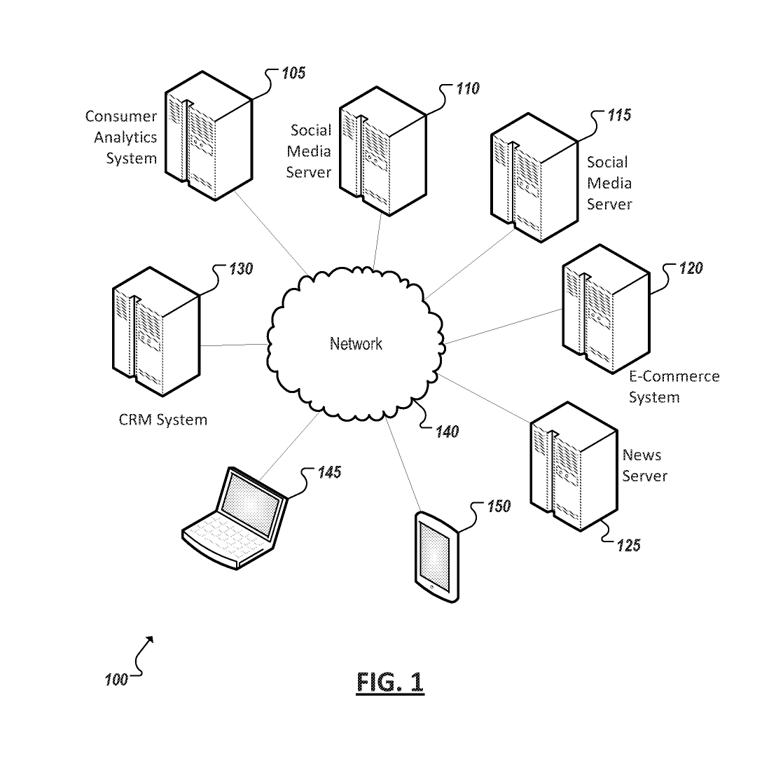

In one implementation, as represented in the simplified block diagram of FIG. 1, a system can be provided that includes a consumer analytics system 105 that can generate occasion-based consumer analytics through the application of a four-factor model (Attitudinal, Sociocultural, Personal, and Behavioral) for mining consumer insights from social data that combines research in consumer and social psychology, discourse processing, and sentiment analysis. Social data can be extracted from online social media services and platforms, which provide a medium for consumers to rant, rave, and recommend products, brands, and companies in an authentic manner. Such social data can be collected from sources such as various social media platforms hosted by social media servers (e.g., 110, 115), from e-commerce systems (e.g., 120) that user reviews and ratings of various products and services, news servers (e.g., 125) and other platforms providing discussion boards and user comments in connection with general or specialized (e.g., market-specific) news reports, among other examples.

Within the content of social data, consumers may be expressing their genuine beliefs about products and services without thought for how the content they publish informs the producers or competitors of these products and services. Moreover, social media posts can have an amplifying effect, as the decisions and opinions of other consumers may be influenced by the feedback and posts of others. Accordingly, for companies, social data can represent a potential for insights to the when, where, how, and why their products are used, who is buying them, who is using them, and information about those individuals' including their associated beliefs, needs, wants, and preferences. These insights can facilitate marketers' understanding of consumer behavior and can be used to better build, design, and market their products and services to meet consumer need and desire. Accordingly, in some implementations, a consumer relationship management (CRM) system (e.g., 130) or other system can interface with the consumer analytics system to consume consumer analytics result data and services provided by the consumer analytics system to obtain intelligence that can be used by a company to enhance the marketing, customer service, and product development efforts of the company, among other examples.

Continuing with the example of FIG. 1, one or more of the systems (e.g., 105, 110, 115, 120, 125, 130) can be communicatively coupled via one or more local and/or wide area networks (e.g., 140), including the Internet. For instance, elements of the consumer analytics system 105 can connect to and pull, collect, or receive data, or “documents”, from the social data host systems (e.g., 110, 115, 120, 125) over a network 140. Likewise, applications (such as those hosted on CRM system 130) can interface with the consumer analytics system 105 over one or more networks 140 to obtain and consume consumer analytics data generated by the consumer analytics system 105.

In some implementations, a system 100 can further include one or more user devices (e.g., 145, 150) to allow users to interface with applications, services, and content of one or more systems (e.g., 105, 110, 115, 120, 125, 130) over a network (e.g., 140). For instance, users may connect to social data servers (e.g., 110, 115, 120, 125) to author new social data in connection with a discussion board, review, messaging platform, or social media platform, among other examples. Users may also access social data and other content from social data servers (e.g., 110, 115, 120, 125) using user devices (e.g., 145, 150). User devices (e.g., 145, 150) may also be used to interface with consumer analytics system 105. For instance, users can request and consume consumer analytics data from the consumer analytics system 105. In some examples, users can interface with a CRM system or other system that is a client of the consumer analytics system 105 to utilize or access consumer analytics results from the consumer analytics system 105. Users can also interface with the consumer analytics system 105 to provide guidance for machine learning and natural language processing logic hosted at the consumer analytics system 105 and improve results generated by the consumer analytics system 105, among other example interactions and uses.

As will be appreciated by one skilled in the art, aspects of the present disclosure, including the system of FIG. 1, may be illustrated and described herein in any of a number of patentable classes or context including any new and useful process, machine, manufacture, or composition of matter, or any new and useful improvement thereof. Accordingly, aspects of the present disclosure may be implemented entirely in hardware, entirely software (including firmware, resident software, micro-code, etc.) or combining software and hardware implementations that may all generally be referred to herein as a “circuit,” “module,” “component,” or “system.” Furthermore, aspects of the present disclosure may take the form of a computer program product embodied in one or more computer readable media having computer readable program code embodied thereon.

Any combination of one or more computer readable media may be utilized. The computer readable media may be a computer readable signal medium or a computer readable storage medium. A computer readable storage medium may be, for example, but not limited to, an electronic, magnetic, optical, electromagnetic, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), an appropriate optical fiber with a repeater, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable signal medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Scala, Smalltalk, Eiffel, JADE, Emerald, C++, CII, VB.NET, Python or the like, conventional procedural programming languages, such as the “C” programming language, Visual Basic, Fortran 2003, Perl, COBOL 2002, PHP, ABAP, dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Aspects of the present disclosure are described herein with reference to flowchart illustrations and/or block diagrams of methods, apparatuses (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks.

These computer program instructions may also be stored in a computer readable medium that when executed can direct a computer, other programmable data processing apparatus, or other devices to function in a particular manner, such that the instructions when stored in the computer readable medium produce an article of manufacture including instructions which when executed, cause a computer to implement the function/act specified in the flowchart and/or block diagram block or blocks. The computer program instructions may also be loaded onto a computer, other programmable instruction execution apparatus, or other devices to cause a series of operational steps to be performed on the computer, other programmable apparatuses or other devices to produce a computer implemented process such that the instructions which execute on the computer or other programmable apparatus provide processes for implementing the functions/acts specified in the flowchart and/or block diagram block or blocks.

While FIG. 1 is described as containing or being associated with a plurality of elements, not all elements illustrated within system 100 of FIG. 1 may be utilized in each alternative implementation of the present disclosure. Additionally, one or more of the elements described herein may be located external to system 100, while in other instances, certain elements may be included within or as a portion of one or more of the other described elements, as well as other elements not described in the illustrated implementation. In some cases, functionality of a particular system (e.g., consumer analytics system 105), may be hosted entirely on a single computer, while in other implementations the system may be hosted on multiple devices such as a distributed computer system (e.g., the cloud). Further, certain elements illustrated in FIG. 1 may be combined with other components, as well as used for alternative or additional purposes in addition to those purposes described herein.

Traditionally, the volume and trend of positive and negative comments, reviews, tweets, etc. is used as a proxy for brand awareness and placement against competitors (or “competitive intelligence”). An evolution of this is aspect-based sentiment analysis in which sentiment is associated with aspects and higher-level aspect categories for a given target entity, such a product or brand. As an example, in the sentence:
“The screen is big and bright.”
   a positive sentiment is associated with the aspect “screen” with “big” and “bright” are desirable qualities. “Screen” in turn is linked to a “display” category. However, aspects and sentiment alone do not fully capture the implicatures found in social data, which inform to the attitudes and behavior of the consumers. As additional examples, consider:
1. “I would totally recommend any other laptop over this pile of garbage.”
2. “I know my child needs to know computers to be successful, but I just can't afford a computer.”
3. “For Park Avenue I expected so much more.”

In the first example the reviewer's negative sentiment for the product (laptop) is strong enough that they recommend others to not buy. Recommending or suggesting to others a course of action is a directive speech act, which originates from directive modality, while the polarity of the act is captured through sentiment analysis (e.g. recommending not to purchase would be negative sentiment) the greater implicature is lost, i.e. the loss of a customer and possible loss of other potential customers within their social network. In the second example the commenter expresses a need, such as a cognitive need, for their children to have knowledge of computers. However, they are unable to meet this need because of the cost. While current sentiment-based approaches identify a negative sentiment associated with “cost”, the greater insight is the loss of a customer who desires the product, but lacks the financial resources to obtain it. Finally, in the third example the commenter expresses disappointment as their expectations were not met. Understanding what their expectations were and how and why they were not met facilitates meeting those and others' expectations in the future.

Marketers can gain insights about consumers by identifying the occasions in which consumers use their products and which occasions are invoked by their products. Identifying such occasions can help in consumer segmentation, answering why consumers purchase a product, and where and when they use it. Additionally, the types of occasions a consumer participates in and the social settings surrounding those occasions can provide insights into the consumer's personality and sociocultural self. Insights such as these are desirable for understanding consumer behavior, which marketers can use to better design and sell their products. Systems can be provided, employing hardware and/or software logic, to extract and categorize occasions from product reviews, product descriptions, and forum posts. For instance, a maximum entropy Markov model (MEMM) and/or a linear chain conditional random field (CRF) can be used for extraction and to find the CRF results in a 63.4% F1-measure. Extracted occasions can be categorized as one of a variety of high-level types (e.g., Celebratory, Special, Seasonal, Temporal, Weather-Related, and Other) using a support vector machine with an 88.5% macroaveraged F1-measure.

Social media services provides an outlet for consumers to discuss, praise, chastise, and recommend products and services. These consumer-generated reviews and commentaries provide marketers insight into the who, what, when, where, why, and how (i.e. the six W's) surrounding the procurement and usage of their products. One way in which marketers answer the six W's is by identifying the occasions, particular times or events, in which their products are used or with which consumers associate their products. These occasions may be routine, e.g. “work” or “at the office”, seasonal/weather related, e.g. “rainy day” or “winter”, special, e.g. “birthday” or “Christmas”, or time related, e.g. “on the run” or “early morning.” More than just answering the six W's, occasions also provide a marketer insight into the personality, social status, social circle, and behavior of consumers.

Marketers traditionally rely upon surveys and ethnographic studies in order to gain insights about consumers. The results of these surveys and studies are: (1) consumer segments; (2) when and where the respondents are likely to purchase or use a product; (3) whether they are likely to use the product alone or with others; (4) whether or not the respondents like the product; and (5) are the respondents likely to purchase the product again. These surveys and studies are costly and limited to a much smaller sample size than is obtainable via online reviews and social media. However, current computational approaches to gaining consumer insights typically are limited to the volume and trend of positive and negative comments, reviews, tweets, etc.

Consumer and social psychology, dialogue processing, and affective computing can allow a computational system to replace surveys for consumer insights to identify consumers' needs, desires, and behavior. Critical to the success of such a computational system is the automated extraction of the occasions in which consumers use a product or with which they associate a product. These occasions and their implicatures provide answers to the “six W's” and are a basis for understanding a consumer's personal and sociocultural self.

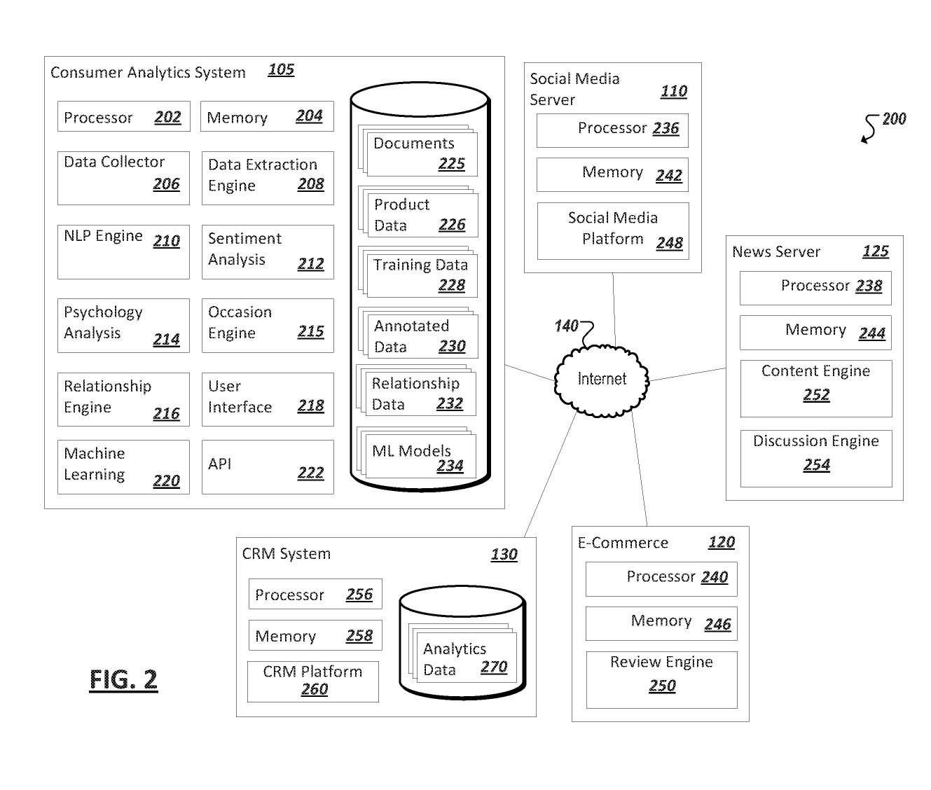

Systems, such as those described and illustrated in connection with the examples of FIGS. 1 and 2, can provide at least some of the machine-implemented functionality and address at least some of the issues discussed above. For instance, as shown in the simplified block diagram 200, a system can include a consumer analytics system 105, which can utilize social data included in documents (e.g., 225) obtained one or more sources of social data, such as social media servers (e.g., 110), e-commerce servers (e.g., 120), news servers (e.g., 125), etc.

In one example, a consumer analytics system 105 can include one or more data processing apparatus 202, one or more memory elements 204, and machine-executable logic components (implemented in hardware, firmware, and/or software) such as a data collector 206, data extraction engine 208, natural language processing engine 210, sentiment analysis engine 212, psychology analysis engine 214, occasion identification engine 215, relationship engine 216, user interface engine 218, machine learning engine 220, and one or more application programming interfaces (APIs) (e.g., 222), among others (or executable blocks, which combine or further sub-divide the functionality of the above components).

In one implementations, a data collector 206 can obtain documents 225 containing social data from one or more social data sources (e.g., 110, 120, 125). A “document” within this context is any file, report, or portion of data, or report that identifies text within content of a particular source (e.g., 110, 120, 125), such as one or more social media posts generated on a social media platform 248, online news content (such as an article, blog post, etc.) generated by a news server 125 (using content engine 252) or using a related discussion engine (e.g., 254), product or service reviews on one or more ecommerce or consumer review websites (e.g., hosted by e-commerce server 120 and generated using a review engine 250), among other examples. A data collector 206 can receive feeds from the source directly or through an intermediary source or service aggregating such data. In some implementations, data collector 206 can include a bot or crawler, which trolls social data sources and collects text and other data from the content of these sources, among other examples.

In one example, a data extraction engine 208 can be provided to identify text data that likely represents a consumer sentiment. The data extraction engine 208 can thus differentiate between text that is extraneous to user posts and isolate that text of most value for extracting consumer sentiment information. A data extraction engine 208 can also extract information, such as from news, weather, or calendar content of a source, to identify particular events that may map to occasions. Isolated text can be processed using a natural language processing (NLP) engine 210 (employing one or more natural language processing algorithms and approaches) to determine semantics and context of words, phrases, clauses, sentences, paragraphs, etc. within the text. Accordingly, an NLP engine 210 can process data to associate meaning (e.g., pre-defined or known definitions and contexts) to words within the text.

Upon identifying the semantic meaning of various user posts within the text of documents 225, a sentiment analysis engine can further process the post data to determine whether consumer sentiment is likely expressed in the text as well as to determine a type of sentiment expressed in the text. Sentiment can be supplemented by processing the text data using a psychology analysis engine 214, which can parse the text to determine psychological characteristics of the text's author as well as additional context of the text's meaning. For instance, a psychology analysis engine 214 can apply a multi-factor model based at least in part on psychology of an author as predicted from the terms used by the author as well as the personal characteristics of the author. In some instances, capturing deeper insights, such as recommendations, preferences, and needs, can involve more than just rote sentiment analysis. Instead, metrics from dialogue processing and psychology (e.g., embodied in logic and models of the psychology analysis engine 214 can be combined with sentiment analysis (e.g., provided by sentiment analysis engine 212) to create a complete model from which all consumer related implicatures can be mined to produce actionable insights. In one implementation, a four-factor model can be defined that incorporates considerations from consumer and social psychology, dialogue processing, and sentiment analysis. In one example, the four factors include: Attitudinal, Sociocultural, Personal, and Behavioral. Attitudinal factors can define consumers' beliefs, needs, wants, and preferences. Sociocultural factors can refer to the influence in decision making arising from the consumers' culture and group identity and their role and status in it. Personal factors can include psychographics (e.g. personality) and demographics (e.g. age and gender). Behavioral factors can inform to the motivations, intentions, actions and ability to perform those actions, e.g. buy a new car. These four factors interact and influence one another. For example, personal factors and social factors have direct impacts on beliefs (attitudinal factor) and behavior, among other examples.

In one example, consumer analytics system 105 can additional provide an occasion identification engine 215 to map user posts in the social data of documents 225 to identified occasions, or events having social significance. Text data embodying these posts can be annotated to identify a mapping to one or more determined occasions, to generate annotated data 230. Determined user sentiments can be mapped to these identified occasions. Products and services can further be mapped to these occasions, and relationships between occasions and sentiment, occasions and products/service, or event relationships between occasions, products/services, and sentiment relating to these products/services can be determined and defined (e.g., in relationship data 232). Product data 226 can additionally be provided to identify products and services together with respective branding, slogans, related companies, ad campaigns, people, markets, and other characteristics from which associations can be derived (e.g., by relationship engine) between text evidencing a consumer sentiment and/or occasion and the product or service.

Machine learning models (e.g., 234) and logic (e.g., 220) can be utilized to identify patterns in text from which sentiment, psychology, occasion, and relation determinations and metrics can be defined. In some cases, training data 228 can be provided to train machine learning logic 220. Machine learning logic 220, in some instances, can be human assisted to allow human users (e.g., through user interface 218) to fine tune the machine learning logic by identifying errors in the machine learning logic's determinations to assist machine learning logic 220 in making the correct determination in a future instance. It is anticipated that human assistance will decrease as the machine learning logic and its associated models respond to the human assistance and automatically adjust to the feedback.

As noted above, consumer analytics result data can be generated based on relationships defined between occasions, products, and sentiment determined using the consumer analytics system 105. For instance, result data can identify trends, patterns, statistical metrics, events, and other intelligence usable by other applications and services, such as applications relating to improving consumer engagement, customer service, product development, marketing, etc. For instance, an application, such as CRM system 130, may make use of an API 222 provided by the consumer analytics system 105 to obtain and use consumer analytics result data (e.g., 270) generated by the consumer analytics system 105.

Servers and devices within the system can each include one or more processing apparatus (e.g., 236, 238, 240) and one or more memory elements 244 to implement machine executable code, executable by a processor to realize respective functionality of one or more modules, applications, or services, such as social media platform 248, content engine 252, discussion engine 354, review engine 250, CRM platform 260, etc.

Occasions in product reviews, product descriptions and forum posts can be automatically extracted and categorized using systems, methods, and executable logic described herein. In one example, the extraction of occasions (e.g., by occasion identification engine 215) can be cast as a sequence labeling problem using Begin, In, Out (BIO) encoding. Extracted occasions can be categorized as one of six high-level types, Celebratory, Special, Seasonal, Temporal, Weather-Related, and Other, based on common occasions marketers seek to capture in surveys.

Some systems utilize event extraction. Event extraction deals not only with the extraction of events, but also with the extraction of the entities participating in the events, and other attributes of the event, such as the time, location, and modality. Despite the advances in the extraction of events, the definition of an “event” is often ill-defined and changes based on the problem being solved. For instance, the Automated Content Extraction (ACE) program defines events using a limited set of types. For instance, TimeML encoding can be leveraged, which defines events as “situations that happen or occur” and focuses on the duration properties of the event. Instead of precisely defining what an event is, event extraction may merely identify the qualities representative of events.

Social media's wide spread acceptance and adoption has facilitated an extensive corpus of user-created expressions that can be mined for real-time event detection and extraction. Social media sites (e.g., 110) like Twitter™ and Facebook™ can effectively act as social sensors facilitating the real time detection of disasters, protests, and other local events. For instance, relying on the real-time nature of Twitter™ and the volume of tweets around unusual or significant events, real-time earthquake and weather events can be detected using Twitter™ users' accounts and posts as “sensors.” Unusual local events happening in a given geographic area can also be detected based on the regularity of tweets against the normal behavior of Twitter™ users in the area.

The dialogue that takes place over social media also makes it possible to find and extract life and social events for such purposes as detecting online bullies and suicide prevention target specific replies on Twitter™ containing manifestations of speech acts, namely congratulations/condolences, to extract major life events, e.g. marriage, using a distant-supervised approach. In addition to the detection of events, work has been done on identifying the social implicatures of dialogue which is in response to a set of events (e.g. Wikipedia page edit) or which may lead to a series events (e.g., change in leadership), among other examples.

Broader related research on mining consumer insights can be found by applying consumer psychology and affective computing. Consumer psychology can pertain to measuring how thoughts, feelings, and perceptions influence the way individuals buy, use, and relate to products, services, and brands. Drawing from this and other areas in psychology, e.g. social psychology, the cognitive system of consumers can be formalized using a categorical representation of products, services, brands and other marketing entities. Links can be defined between the prototypicality of a product and consumers' affect toward it (e.g., using psychology analysis engine 214).

One component to understanding consumers' affect toward a product is identifying the brands, products, and attributes (or aspects) of the product consumers are mentioning. In one example, product types can be separated from brands, e.g. “soda” vs “coke”, using a ranking based approach which alleviates the need for labeled data. In another example, a named entity recognition system can be used to extract product attributes from listing titles on ecommerce websites (e.g., 120), such as eBay™ or Amazon™. Such systems can focus on extracting brand, style, size, and color within in the clothing and shoes categories. In another particular example, a WordNet-based approach can be used to construct hierarchical facets relating to aspects associated with a domain or product. A domain assisted approach can also be used to construct aspect hierarchies.

Aspect-based sentiment analysis (e.g., through sentiment analysis logic 212) can merge affect and information extraction seeking to determine the sentiment toward aspects of products, e.g. the consumer sentiment toward the screen of a TV or the food at a restaurant. For instance, aspect term identification can utilize such examples as BIO encoding and rule-based approaches. Techniques for aspect polarity detection include machine learning based techniques that integrate multiple sentiment lexicons to grammar based approaches.

More general than aspect-based sentiment analysis is sentic computing. Sentic computing synthesizes common-sense computing, linguistics, and psychology to infer both affective and semantic information about concepts. Sentic computing principles can be embodied in sentiment analysis engine 212 logic and can be used to detect topics and determine polarity in patient opinions. Further, syntatic patterns can be determined and used to examine the needs and wants of consumers and analyze the demand for products. Customer wishes can be detected in reviews and surveys in which consumers make suggestions for improvements and show their intentions to purchase/use a product using some implementations of sentiment analysis engine 212.

Occasions can be particular times or events and range from the everyday, such as waking up and going to bed, to the special, such as birthdays and weddings. While every occasion is of importance, those surrounding products can be very useful to marketers for gaining insights into consumer behavior. Thus, in the context of consumer analysis, occasions can focus on those occasions, which are related to a product or service. An “occasion,” as identified by occasion identification engine 215, can include those times or happenings in which a product is used or with which a product is associated. For instance, text based resources evidencing customer sentiment connected to an occasion can include such examples as:
1. “They are GREAT to take along to a party if you're serving crackers and cheese.”
2. “I bought these for my vacation and they did not disappoint.”
3. “Boy, do these take me back to those misspent days of my foolish youth.”
   In the first example the occasion is a party relating to where the reviewer used the product. From this example it can be inferred, for instance, that the occasion of use is social, i.e. involved more than just the reviewer, and most probably is informal. Furthermore, it can be inferred that the reviewer believes the product is well suited for party occasions. Given further context about the kind of party, e.g. kids or work, would lead to further insights about the individual, such as if they have children, their age, their occupation, and their marital status. In the second review the occasion (“vacation”) is the reason for the reviewer to purchase the product and the answer to when the reviewer used it. Moreover, from the review it can be inferred that the use of the product was a positive experience for the reviewer. The third review is an example of how a product can be associated with an occasion, which in this case is a memory of the reviewer's youth. Marketers can use these type of occasions to connect with consumers at a subconscious and emotional level.

While occasions are closely related to events, not all fit nicely within the ACE and TimeML definitions. For example, take the following:
1. “These boots really kept me warm during the winter.”
2. “Every time I smell a freshly baked apple pie it brings me back to my childhood.”

In the first example the product is a pair of boots and the occasion of use is the winter. Within an event framework, winter would be not be identified as an event, but as a temporal attribute possibly of a “keep warm”. In the second example the occasion is “brings me back to my childhood” and is associated with the product (“apple pie”) by the reviewer. The event in the sentence is a “baking” event with the apple pie being the item baked. The occasion is tangential to the event and most likely would not be associated with it by an event extraction system. However, this type of occasion can provide and be used by the consumer analytics system 105 as evidence of a strong connection between the product and a specific time or event that is nostalgic for the consumer and is invaluable for marketers when crafting their marketing strategy.

Often occasions are associated with special events, such as ceremonies and celebrations. However, as with event types, there are a number of different types of occasions. For instance, six high-level occasion types can be defined, as shown in Table 1.

TABLE 1
Example high-level occasion types used to categorize occasion mentions

| Occasion Type | Definition |
|---|---|
| Celebratory | Occasions meant to celebrate an event, person, or group |
| | of people (e.g. parties and award ceremonies) |
| Special | Occasions which have significant importance to an |
| | individual or group of individuals (e.g. holidays and |
| | life events) |
| Seasonal | Occasions related to the seasons of the year. (e.g. winter) |
| Weather- | Occasions strongly associated with the weather and/or |
| Related | temperature. (e.g. hot days and rainy nights) |
| Temporal | Occasions tied to a specific time (e.g. 9 to 5, late night, |
| | and last year) |
| Other | Occasions which do not fit in the other categories (e.g. |
| | a shopping spree, at the beach) |

Occasion types can correspond to consumer segmentation boundaries, in some implementations. The first type of occasion in this example is Celebratory, which include parties and festivals, are social occasions and inform to the group with which the consumer belongs. An example of a celebratory occasion is:
“I wore it a couple weeks ago to a party and felt festive yet as comfy as if I was wearing loungewear.”

Some celebrations are due to special occasions. Special occasions are those which have significant meaning to the consumer, such as holidays and religious observances. The following review excerpt contains mentions of two special occasions:
“I recommend these for your engagement party or rehearsal dinner.”
   Temporal and seasonal occasions relate to the time in which a product is used or associated. An example of a seasonal occasion is:
“A quintessential style to take you between seasons.”
   The following excerpt from a product description contains two suggested temporal occasions of use:
“Just the right size for your day-to-day life, but elegant enough for evening.”
   Weather-related occasion relate to the weather, e.g. rain and snow, or temperature, e.g. hot and 98 degrees. Two examples of weather-related occasions are seen in:
“The tea is great hot for chilly nights and iced for hot days.”
   Finally, an “other” type of occasion can also be defined for occasions that do not neatly fit in one of the other five categories. An example of an occasion that is marked as other could be:
“Taking a look at the latest summer fashion makes me want to lie on the beach.”
   Additional enumerated occasion types can be defined beyond those explicitly named in the examples herein.

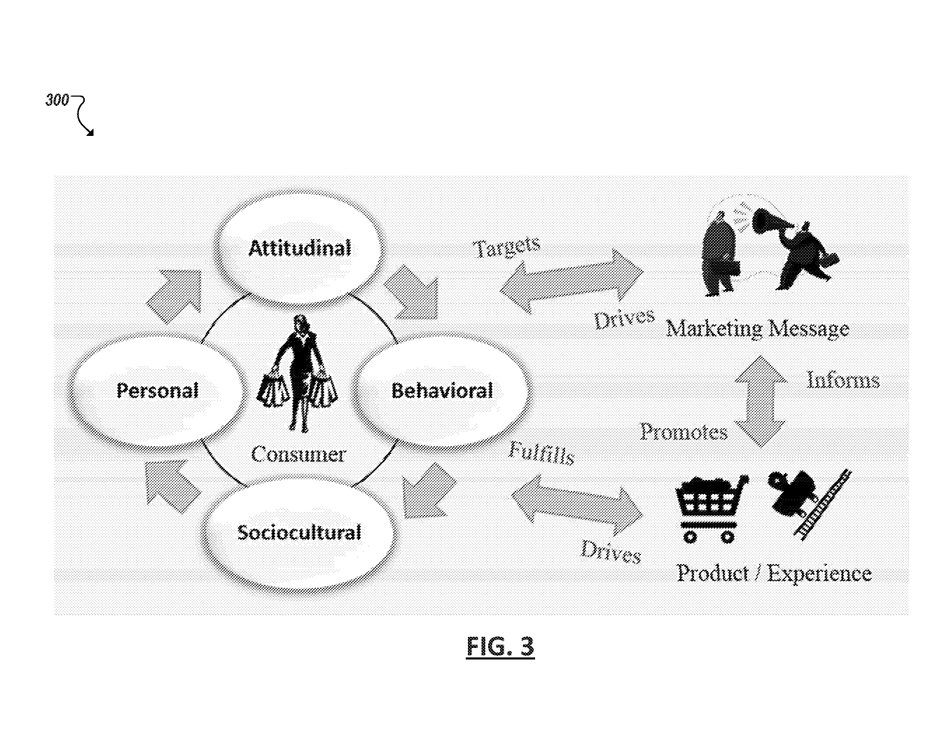

The extraction and categorization of occasions is an important component in understanding the consumer as occasions provide glimpses into a consumer's personality and sociocultural self. Occasions can be used as a source for insights within a four factor model in order to infer consumer behavior and aid marketers in better meeting the needs and desires of their customers. Such as illustrated in the representation 300 of FIG. 3, such a model can be grounded in consumer and social psychology, discourse processing, and sentiment analysis. The four factors inform to consumers' attitudes, behavior, sociocultural self, and personal qualities. Information from

Attitudinal factors define consumers' beliefs, needs, wants, and preferences. Sociocultural Factors refer to the influence in decision making arising from the consumers' culture and group identity and their role and status in it. Personal factors include psychographics (e.g. personality) and demographics (e.g. age and gender). Behavioral factors inform to the motivations, intentions, actions and ability to perform those actions, e.g. buy a new car. They blend together with each factor interacting and influencing the others and ultimately the beliefs, needs, and wants of a consumer.

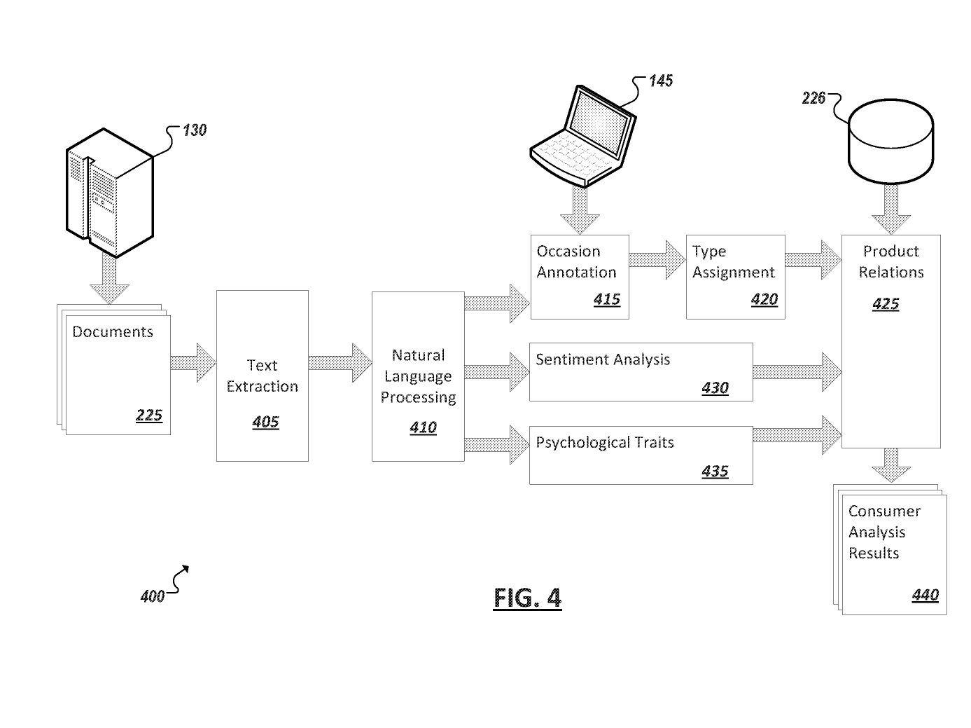

Turning to the simplified flow diagram 400 of FIG. 4, text data from one or a variety of sources can be mined to extract sentences and phrases from multiple data sources, such as product reviews, product descriptions, and forum posts discussing such products as fashion and food related products for annotation to identify an occasion and/or consumer sentiment related to the text. In the example of FIG. 4, documents 225 can be obtained from a source of social data 130 and can be processed to extract text data (at 405) from the documents 225. The text data can then be submitted to natural language processing 410 by the consumer analytics system to determine meanings of individual words within sentences and paragraphs of the text, as well as to derive the context or broader meaning of the sentence, paragraph, etc.

With the semantic meaning of segments of text data determined, further processing can be performed to generate elements of consumer analytics information relating to these segments of text data (e.g., corresponding to individual or collections of related social media posts). For instance, occasions can be detected within a post, and these posts can be annotated (e.g., with metadata, tags, or other identifiers) to identify that evidence of an occasion is present within the post. Further, the annotations can identify the occasions, with potentially multiple distinct posts from multiple different authors and platforms mapping to the same type or instance of an occasion. In one example, an iterative annotation process can be used to automatically identify occasions within a post, sentence, or phrase. During each iteration, automated machine annotation can be performed followed by manually correction, where desired (e.g., by a use of user device 145). In one example, during the initial iteration automated machine annotations can be produced using a gazetteer and successive iterations use a machine learning model. As an example, manual correction of the machine annotations can involve: (1) removing incorrect occasions; (2) adding missed occasions; and (3) fixing boundaries of partially correct occasions.

In one example, to assist in training or improving the machine learning logic used in occasion identification, an initial iteration of the annotation process can be performed on a set of randomly selected sentences. The gazetteer logic used during the initial iteration is semi-automatically constructed using Word-Net. The full hyponym tree and all derivationally related forms for social event, time period, and the first noun sense of activity may be mined and added to the gazetteer. Examples of occasions identified using the gazetteer may be as follows:
1. “Darling cocktail party or date night dress.”
2. “We only stayed at the party an hour because my shoes were killing my feet.”
   After manual correction of the initial set of sentences is performed, a subset can be selected and held out as test data for occasion extraction. The remaining sentences in the set not included in the subset can be used as training data for the machine learning model in the second iteration.

The second and successive iterations work on batches of sentences detected within text of documents 225. At each iteration a machine learning model can be further trained and then used to extract occasions in the new batch of sentences. During each iteration the model used to train may be switched. For instance, models may be alternated to ensure against a bias toward one model and because each model may possibly find something the other did not. The machine identified annotations may be thereafter corrected and added to the set of training data for the next iteration. This process may be repeated until all sentences are annotated. In one illustrative example, 2,393 occasions are annotated across a set of 26,208 sentences making up a corpus (of documents (e.g., 225), resulting in an average of 1 occasion per every 11 sentences. In this example, there is approximately 1 occasion mentioned per product review and forum post and 1 occasion mention every 3 product descriptions. Similar techniques can be employed to identify instances of consumer sentiment evidenced in sentences of documents 225 (during sentiment analysis 430) and to associate words within social data segments, or posts, with psychological characteristics, such as those defined in the four-factor model discussed above (during psychological train analysis 435). Similarly, posts or portions of posts (e.g., sentences) determined to include consumer sentiment or particular psychological identifiers can be corresponding annotated to identify this evidence within the consumer analytics system.

Continuing with the example of FIG. 4, in the case of occasion annotation, following annotation of a particular sentence or post, based on the detected presence of an occasion within the expression of the text (at 415), one or more respective occasion types can be assigned to each of the annotated occasions. In one example, WordNet can be used to assign an initial type. In some cases, further human assistance can be provided to help train the logic of the occasion identification engine to correct any incorrectly-assigned type labels. A mapping between a set of seed senses and occasion types can be generated, such as represented in Table 2, for instance using WordNet. In some examples, the full subtree and all derivationally related forms of each seed sense can be extracted and assigned to the seed's associated occasion type. In some implementations, the extraction and categorization of occasions can be divided into two different tasks (e.g., as shown in the example of FIG. 4). In other implementations, however, the tasks (e.g., 415, 420) can be performed jointly.

TABLE 2
Example seed senses for mapping senses to occasion types

| Sense | Occasion Type |
|---|---|
| party#N#4 | Celebratory |
| celebration#N#1 | Celebratory |
| season#N#2 | Seasonal |
| temperature#N#1 | Weather-Related |
| day#N#1 | Temporal |
| day#N#2 | Special |
| valentine#N#1 | Special |
| gift#N#1 | Special |
| anniversary#N#1 | Special |
| birthday#N#1 | Special |
| special#A#3 | Special |
| New Year#N#1 | Special |

WordNet lemmas found in a given occasion annotation can be examined in right-to-left order. All senses for a lemma are considered in order of sense number. Assignment can be performed greedily with the type of the first sense found in the mapping being assigned to the occasion. The Other type is assigned if no mapping is found. After the automatic assignment is complete the types are manually corrected. The breakdown of the number occasions of each type in one illustrative example is shown in Table 3.

TABLE 3
The number of occasions annotated for the six high-level types.

| Type | Count |
|---|---|
| Celebratory | 107 |
| Seasonal | 525 |
| Special | 336 |
| Temporal | 263 |
| Weather-Related | 48 |
| Other | 1,114 |

In one example, the extraction (or detection) of occasions can be modeled using standard BIO encoding. For instance, words in a sentence can be labeled as B-Occasion, Occasion, or Other depending on if the word begins an occasion phrase, is within an occasion phrase, or is outside of an occasion phrase respectively. In some examples, a maximum entropy Markov model (MEMM) and/or a linear chain conditional random field (CRF) model can be used to perform extraction. In one example, an implementation of MEMM can be employed that uses the LibLinear library and CRFsuite can be used for the CRF implementation. Default parameters can be used for LibLinear (L2 regularization) and CRFsuite.

Example feature templates that may be used for the extraction of occasions are represented in Table 4. In Table 4, w₁; . . . ; wₙ are the words in the sentence and wᵢ the current word; p₁; . . . ; pₙ is the part-of-speech sequence for the sentence and pᵢ is the part-of-speech for the current word wᵢ; sense (wᵢ) returns all possible senses for the current word, wᵢ, and ssᵢⱼ is the super sense associated with sense j; and tᵢ is the tag assigned to the i'th word. The features can consist of surface, syntactic, and semantic information about the word and its context. Syntactic information can be in the form of part-of-speech information and semantic information can be in the form of WordNet super sense, i.e. lexicographer filenames. These features, with the exception of the WordNet-based feature, can be used in other sequence labeling tasks, such as shallow parsing and named entity recognition. In one implementation, features that occur only once are eliminated in the training set.

TABLE 4
Feature templates used for extracting occasions.

| | | |
|---|---|---|
| Current word | wᵢ | & tᵢ |
| Current word & POS | wᵢ, pᵢ | & tᵢ |
| Previous word & POS | wᵢ₋₁, pᵢ₋₁ | & tᵢ |
| Word two back & POS | wᵢ₋₂, pᵢ₋₂ | & tᵢ |
| Next word & POS | wᵢ₊₁, pᵢ₊₁ | & tᵢ |
| Word two ahead & POS | wᵢ₊₂, pᵢ₊₂ | & tᵢ |
| Bigram word | wᵢ₋₂, wᵢ₋₁ | & tᵢ |
| | wᵢ₋₁, wᵢ | & tᵢ |
| | wᵢ, wᵢ₊₁ | & tᵢ |
| | wᵢ₊₁, wᵢ₊₂ | & tᵢ |
| Bigram word & POS | wᵢ₋₂, pᵢ₋₂, wᵢ₋₁, pᵢ₋₁ | & tᵢ |
| | wᵢ₋₁, pᵢ₋₁, wᵢ, pᵢ | & tᵢ |
| | wᵢ, pᵢ, wᵢ₊₁, pᵢ₊₁ | & tᵢ |
| | wᵢ₊₁, pᵢ₊₁, wᵢ₊₂, pᵢ₊₂ | & tᵢ |
| Trigram word | wᵢ₋₂, wᵢ₋₁. wᵢ | & tᵢ |
| | wᵢ, wᵢ₊₁, wᵢ₊₂ | & tᵢ |
| Current POS | pᵢ | & tᵢ |
| Previous POS | pᵢ₋₁ | & tᵢ |
| POS two back | pᵢ₋₂ | & tᵢ |
| Next POS | pᵢ₊₁ | & tᵢ |
| POS two ahead | pᵢ₊₂ | & tᵢ |
| Bigram POS | pᵢ₋₂, pᵢ₋₁ | & tᵢ |
| | pᵢ₋₁, pᵢ | & tᵢ |
| | pᵢ, pᵢ₊₁ | & tᵢ |
| | pᵢ₊₁, pᵢ₊₂ | & tᵢ |
| Current word is punct. | isPunctuation(wᵢ) | & tᵢ |
| Current word is digit | isDigit(wᵢ) | & tᵢ |
| Current word is letter | isLetter(wᵢ) | & tᵢ |
| Current word is upper | isUppercase(wᵢ) | & tᵢ |
| Current word is lower | isLowercase(wᵢ) | & tᵢ |
| WordNet super sense | Ssᵢⱼ∀sense(wᵢ) | & tᵢ |

Table 5 outlines results in one illustrative example. For instance, extraction performance may be measured using the CoNLL precision (P), recall, and F1-measure in which an occasion is correct if and only if it exactly matches a pre-selected gold standard annotation. Results for the MEMM and CRF are listed in Table 5. As is in seen in the table, in this particular example, the MEMM has the better precision (18.8% increase) and the CRF the better recall (26.2% increase) and F1-measure (9.4% increase).

TABLE 5
CoNLL Precision, Recall, and F1-measure results for extracting occasions.

| Model | P | R | F1 |
|---|---|---|---|
| MEMM | 78.8% | 41.0% | 54.0% |
| CRF | 60.0% | 67.2% | 63.4% |

Examples where the CRF and MEMM extract an occasion correctly may be, for example:
1. “Just what you need for a hot summer day!”
2. “We (my son and I) purchased this gift set for my wife on Valentine's day.”
3. “It's the perfect size to take me from a day at work to a night out for drinks with friends.”

In the first example, the occasion (“hot summer day”) is a noun phrase representing the reviewer's belief of a good time to use the product. In the second example the occasion is a holiday (“Valentine's day”). The final example contains two occasion mentions that represent a time range, in the form of from time₁ to time₂.

Once an occasion is extracted its type is determined. The task of determining the type of a given occasion is an example of a short-text classification problem. To solve this task a multi-class support vector machine can be used, such as implemented in the LibLinear library. In one example, the default values of C and ε are used.

In one example, three features are used for determining the type of an occasion. The first is the standard bag of words with words normalized to lowercase. The second feature is the WordNet super senses of all possible senses found in the occasion. The super senses for adjectives and adverbs in WordNet are not as well defined as they are for nouns and verbs. Because of this, the super sense for the associated noun sense Is used using the derivationally related for adjectives and the pertainym (adverb to adjective) and derivationally related form (adjective to noun) relations for adverbs. The final feature can be the SUMO concepts associated with all WordNet senses in the occasion.

Table 4 lists the 10-fold cross-validation results for determining the type of a given occasion in accordance with one illustrative example. As is seen in Table 4, in this example, F1-measures range from 71.9% for weather-related to 96.7% for seasonal.

TABLE 6
10-fold cross-validation Precision, Recall, and F1-measure for categorizing
occasions as Celebratory, Special, Seasonal, Temporal, Weather-
Related, or Other.

| Type | P | R | F1 |
|---|---|---|---|
| Celebratory | 92.6% | 84.7% | 88.5% |
| Seasonal | 95.9% | 97.5% | 96.7% |
| Special | 96.5% | 93.8% | 95.1% |
| Temporal | 80.6% | 88.6% | 84.4% |
| Weather-Related | 78.0% | 66.7% | 71.9% |
| Other | 94.5% | 93.8% | 94.2% |
| Macro Average | 89.7% | 87.5% | 88.5% |
| Micro Average | 93.1% | 93.1% | 93.1% |

Table 7 shows examples of type classifications determined using an example occasion detection system:

TABLE 7
Examples of assignment of types to occasions.

| Phrase | Occasion Type |
|---|---|
| “new spring semester” | Temporal |
| “spend time with the one you love” | Other |
| “shooting your engagement photos” | Special |
| “upcoming year” | Temporal |
| “Halloween party” | Special |

Upon determining occasions in sentences and phrases extracted from mined social media and product review resources, relationships can be identified (at 425) between products and product attributes and occasions. Product and service information can be obtained through product data 226 to assist the consumer analytics system in the detection of words within annotated sentences suggesting a relationship between occasion and the relationship. Relationships can be further identified between a single product (or service) and two or more occasions. Likewise, multiple products (e.g., products within a common product market) can be determined to be related to a single occasion (e.g., suggesting an impact to the product market as a whole), among other examples. Product-occasion relationships detected by the consumer analytics system can include types such as usage and procurement, among other examples. Relationships between occasions can include such examples as standard event relationships, causation, and other examples. Similarly, relationships can be established between products and results of sentiment analysis 430 and psychological analysis 435. Overlaps between these relationships can be identified to identify deeper meaning within a particular post or sentence (e.g., to identify a consumer sentiment related to a product or service based on the occurrence of a particular event), among other examples

Occasions can be used to generate useful outcomes, such as targeted advertising (e.g., someone tweets about taking a camping trip and this sentiment can be used to conclude that the person is now looking for a car and ads for “camping” occasion cars can be pushed to the person) and consumer segmentation (e.g., determining, from occasions, that consumers who camp and hunt may be more similar to one another than consumers who sew), among potentially many other examples. Indeed, consumer analysis results 440 can be generated describing the results of occasion identification (e.g., 415, 40), sentiment analysis 430, and psychological trait analysis 435, as well as from product relations determined (at 425) for these analysis results. Consumer analysis results can be used by companies to better understand their consumers (and potential consumers) and thereby better server their needs and desires through improved products, services, and marketing.

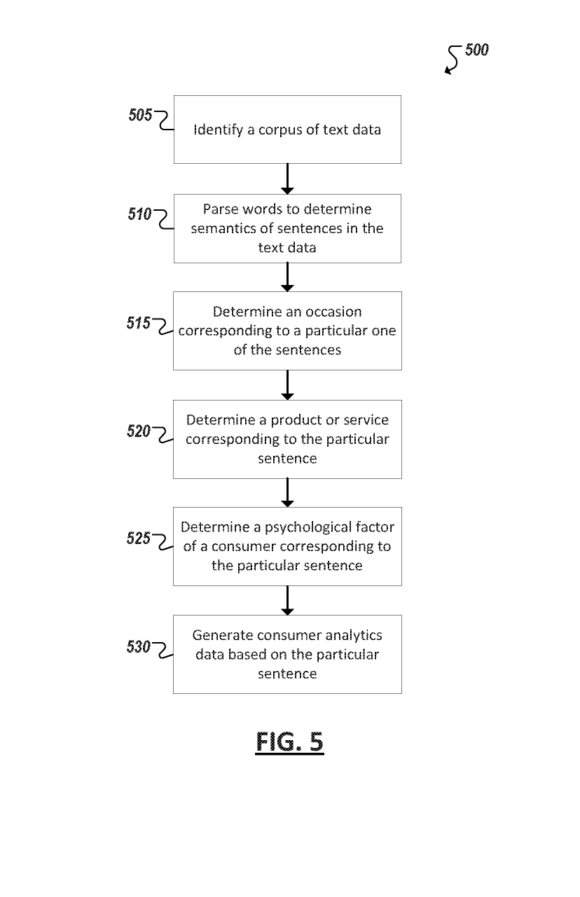

Turning to FIG. 5, a simplified flowchart 500 is shown illustrating example techniques for providing occasion-based consumer analytics. For instance, a corpus of text data can be identified 505 and accessed, as collected, for instance, from multiple different sources of social data, including social network platforms, discussion boards, user comments, etc. The corpus of text data can include distinct documents, or posts, each with one or more phrases or sentences (collectively “sentences”). Words of the sentences can be parsed 510 to determine a semantic meaning for each word, as well as a meaning or context of the sentence, phrase, or paragraph as a whole. In some of the sentences, one or more words may be detected that correspond to an occasion, and the consumer analytics system can determine 515 that the particular occurrence corresponds to at least one particular sentence. Multiple sentences may be determined 515 to correspond to a particular occasion or different instances of occasions of a common type. Such sentences can themselves be linked or associated based on each corresponding to an occasion. Words within the particular sentence may also indicate a correspondence to one or more products, experiences, and/or services. The consumer analytics system can determine 520 that the particular sentence corresponds to the product, experience, or service and define a relationship between the occasion and the product, based on each being determined to correspond to an expression embodied in the particular sentence.

In some instances, a multi-factor psychological model can be applied to sentences in the corpus to further identify psychological characteristics of the respective author of the sentence. For instance, the consumer analytics system can determined 525 that one or more words of the particular sentence indicate a psychological characteristic of an author of the particular sentence. Such psychological characteristics can be used to enhance other conclusions determined by the consumer analytics system for or based on a corresponding sentence. Consumer analytics data can be generated 530 to document the findings of the consumer analytics system, including relationships between products, occasions, consumer sentiment expressed (and determined) within sentences, and consumer psychology, among other information. Such information can be provided to users or other systems for consumption, for instance, as data provided over an API, a GUI rendered to present infographics illustrating relationships determined by the consumer analytics data from social data in the corpus, among other examples.

Although this disclosure has been described in terms of certain implementations and generally associated methods, alterations and permutations of these implementations and methods will be apparent to those skilled in the art. For example, the actions described herein can be performed in a different order than as described and still achieve the desirable results. As one example, the processes depicted in the accompanying figures do not necessarily require the particular order shown, or sequential order, to achieve the desired results. Systems and tools illustrated can similarly adopt alternate architectures, components, and modules to achieve similar results and functionality. For instance, in certain implementations, multitasking, parallel processing, and cloud-based solutions may be advantageous. Additionally, diverse user interface layouts, structures, architectures, and functionality can be supported. Other variations are within the scope of the following claims.

Embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, i.e., one or more modules of computer program instructions, encoded on computer storage medium for execution by, or to control the operation of, data processing apparatus. Alternatively or in addition, the program instructions can be encoded on an artificially generated propagated signal, e.g., a machine-generated electrical, optical, or electromagnetic signal that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. A computer storage medium can be a non-transitory medium. Moreover, while a computer storage medium is not a propagated signal per se, a computer storage medium can be a source or destination of computer program instructions encoded in an artificially generated propagated signal. The computer storage medium can also be, or be included in, one or more separate physical components or media (e.g., multiple CDs, disks, or other storage devices), including a distributed software environment or cloud computing environment.

Networks, including core and access networks, including wireless access networks, can include one or more network elements. Network elements can encompass various types of routers, switches, gateways, bridges, load balancers, firewalls, servers, inline service nodes, proxies, processors, modules, or any other suitable device, component, element, or object operable to exchange information in a network environment. A network element may include appropriate processors, memory elements, hardware and/or software to support (or otherwise execute) the activities associated with using a processor for screen management functionalities, as outlined herein. Moreover, the network element may include any suitable components, modules, interfaces, or objects that facilitate the operations thereof. This may be inclusive of appropriate algorithms and communication protocols that allow for the effective exchange of data or information.

The operations described in this specification can be implemented as operations performed by a data processing apparatus on data stored on one or more computer-readable storage devices or received from other sources. The terms “data processing apparatus,” “processor,” “processing device,” and “computing device” can encompass all kinds of apparatus, devices, and machines for processing data, including by way of example a programmable processor, a computer, a system on a chip, or multiple ones, or combinations, of the foregoing. The apparatus can include general or special purpose logic circuitry, e.g., a central processing unit (CPU), a blade, an application specific integrated circuit (ASIC), or a field-programmable gate array (FPGA), among other suitable options. While some processors and computing devices have been described and/or illustrated as a single processor, multiple processors may be used according to the particular needs of the associated server. References to a single processor are meant to include multiple processors where applicable. Generally, the processor executes instructions and manipulates data to perform certain operations. An apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, module, (software) tools, (software) engines, or code) can be written in any form of programming language, including compiled or interpreted languages, declarative or procedural languages, and it can be deployed in any form, including as a standalone program or as a module, component, subroutine, object, or other unit suitable for use in a computing environment. For instance, a computer program may include computer-readable instructions, firmware, wired or programmed hardware, or any combination thereof on a tangible medium operable when executed to perform at least the processes and operations described herein. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

Programs can be implemented as individual modules that implement the various features and functionality through various objects, methods, or other processes, or may instead include a number of sub-modules, third party services, components, libraries, and such, as appropriate. Conversely, the features and functionality of various components can be combined into single components as appropriate. In certain cases, programs and software systems may be implemented as a composite hosted application. For example, portions of the composite application may be implemented as Enterprise Java Beans (EJBs) or design-time components may have the ability to generate run-time implementations into different platforms, such as J2EE (Java 2 Platform, Enterprise Edition), ABAP (Advanced Business Application Programming) objects, or Microsoft's .NET, among others. Additionally, applications may represent web-based applications accessed and executed via a network (e.g., through the Internet). Further, one or more processes associated with a particular hosted application or service may be stored, referenced, or executed remotely. For example, a portion of a particular hosted application or service may be a web service associated with the application that is remotely called, while another portion of the hosted application may be an interface object or agent bundled for processing at a remote client. Moreover, any or all of the hosted applications and software service may be a child or sub-module of another software module or enterprise application (not illustrated) without departing from the scope of this disclosure. Still further, portions of a hosted application can be executed by a user working directly at a server hosting the application, as well as remotely at a client.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), tablet computer, a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device, including remote devices, which are used by the user.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include any internal or external network, networks, sub-network, or combination thereof operable to facilitate communications between various computing components in a system. A network may communicate, for example, Internet Protocol (IP) packets, Frame Relay frames, Asynchronous Transfer Mode (ATM) cells, voice, video, data, and other suitable information between network addresses. The network may also include one or more local area networks (LANs), radio access networks (RANs), metropolitan area networks (MANS), wide area networks (WANs), all or a portion of the Internet, peer-to-peer networks (e.g., ad hoc peer-to-peer networks), and/or any other communication system or systems at one or more locations.

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results.

What is claimed:

1. A method comprising:
identifying a corpus of text data comprising a plurality of sentences;
parsing, using a data processing apparatus, words of the plurality of sentences to determine, for each word, a corresponding meaning;
determining, using a data processing apparatus, that a particular one of the plurality of sentences corresponds to a particular occasion based on the determined meanings of one or more words of the particular sentence;
determining, using a data processing apparatus, that the particular sentence references a product or service based on the determined meanings of one or more words of the particular sentence;
determining, using a data processing apparatus, a relationship between the product or service and the particular occasion based on the particular sentence; and
determining, using a data processing apparatus, that one or more words of the particular sentence indicate a psychological characteristic of an author of the particular sentence; and
generating consumer analytics data to identify the relationship between the product or service and the particular occasion.

2. The method of claim 1, wherein the psychological characteristic comprises one of an attitudinal, sociocultural, personal, or behavior factor.

3. The method of claim 1, further comprising determining a type of the particular occasion from a plurality of occasion types based a determined meaning of one or more words of the particular sentence.

4. The method of claim 3, wherein the plurality of occasion types comprise celebratory, special, seasonal, weather-related, and temporal occasion types.

5. The method of claim 3, wherein determining the type of the particular occasion is based on a machine-learning model.

6. The method of claim 3, further comprising:
determining at least one other sentence in the plurality of sentences corresponds to another occasion of the same type as the particular occasion; and
defining an association between the particular sentence and particular sentence based on each sentence corresponding to the same occasion type.

7. The method of claim 1, further comprising:
determining, using a data processing apparatus, that one or more words of the particular sentence corresponds to a consumer expression of sentiment relating to the product or service; and
determining a relationship between the particular occasion and the consumer expression of sentiment relating to the product or service.

8. The method of claim 1, wherein determining that the particular sentence corresponds to a particular occasion is based on a machine-learning model.

9. The method of claim 1, further comprising annotating data describing the particular sentence to indicate a correspondence with the particular occasion.

10. The method of claim 1, further comprising determining whether the particular sentence includes a linguistic manifestation of consumer beliefs toward the product or service based on the determining meanings of words of the particular sentence.

11. The method of claim 1, further comprising determining whether the sentence includes a linguistic manifestation of social actions of a consumer based on the determining meanings of words of the particular sentence.

12. The method of claim 1, further comprising determining whether the sentence includes a linguistic manifestation of intentions of a consumer based on the determining meanings of words of the particular sentence.

13. The method of claim 1, further comprising determining, for each sentence, one or more words representing an aspect term based on the determining meanings of words of the particular sentence.

14. The method of claim 13, further comprising determining, for each aspect term, an aspect term polarity.

15. The method of claim 13, further comprising determining, for each aspect term, an aspect category.

16. The method of claim 13, further comprising determining, for each aspect category polarity, an aspect category polarity.

17. The method of claim 1, wherein the corpus comprises posts authored in a social network by a plurality of users.

18. The method of claim 1, wherein the corpus comprises reviews authored in association with an ecommerce website.

19. A machine-readable storage device comprising code operable, when executed by one or more processors, to:
identify a corpus of text data comprising a plurality of sentences;
parse words of the plurality of sentences to determine, for each word, a corresponding meaning;
determine that a particular one of the plurality of sentences corresponds to a particular occasion based on the determined meanings of one or more words of the particular sentence;
determine that the particular sentence references a product or service based on the determined meanings of one or more words of the particular sentence;
determine a relationship between the product or service and the particular occasion based on the particular sentence;
determine that one or more words of the particular sentence indicate a psychological characteristic of an author of the particular sentence; and
generate consumer analytics data to identify the relationship between the product or service and the particular occasion.

20. A system comprising:
one or more processor devices;
one or more memory elements;
a consumer analytics system, executable by the one or more processors to:
identify a corpus of text data comprising a plurality of sentences;
parse words of the plurality of sentences to determine, for each word, a corresponding meaning;
determine that a particular one of the plurality of sentences corresponds to a particular occasion based on the determined meanings of one or more words of the particular sentence;
determine that the particular sentence references a product or service based on the determined meanings of one or more words of the particular sentence;
determine a relationship between the product or service and the particular occasion based on the particular sentence;
determine that one or more words of the particular sentence indicate a psychological characteristic of an author of the particular sentence; and
generate consumer analytics data to identify the relationship between the product or service and the particular occasion.
